(19) United States
(12) Patent Application Publication
(10) Pub. No.: US 2023/0352952 A1
(43) Pub. Date: Nov. 2, 2023

(54) Apparatus for Discharging Battery Units

(71) Applicant: Robert Bosch GmbH, Stuttgart (DE)

(72) Inventors: Christoph Bihler, Fellbach (DE); Sebastian Krieger, Ulm (DE)

(21) Appl. No.: 18/305,663

(22) Filed: Apr. 24, 2023

(30) Foreign Application Priority Data
Apr. 27, 2022 (DE) 10 2022 204 047.3

(51) Int. Cl. H02J 7/00; H02J 7/34

(52) U.S. Cl. CPC H02J 7/0045; H02J 7/0013; H02J 7/34; H02J 7/0047; H02J 7/007

(57) ABSTRACT

An apparatus for discharging battery units includes a plurality of carrier units, with respective battery units arranged on top of each; a conveyor system configured to transport individual carrier units; a buffer station configured to receive and temporarily store carrier units; a discharging station configured to receive individual carrier units from the buffer station; a removal station configured to remove individual carrier units from the discharging station; a contacting assembly configured to generate an electrical contact to carrier units accommodated in the discharging station such that a series circuit of battery units is generated, which are arranged on these electrically contacted carrier units to discharge battery units of this series circuit and to disconnect the electrical contact to individual carrier units individually and independently from one another so that the battery units arranged on these carrier units are removed from the series circuit individually and independently from one another.

This application claims priority under 35 U.S.C. § 119 to application no. DE 10 2022 204 047.3, filed on Apr. 27, 2022 in Germany, the disclosure of which is incorporated herein by reference in its entirety.

The present disclosure relates to an apparatus for discharging battery units and a method for operating such an apparatus.

### BACKGROUND

Accumulators or batteries in (motor or electric) vehicles or in electric drive technology can be supplied to a recycling process after their use at the end of their service life. Furthermore, batteries that have been marked as “not OK” at the end of their manufacturing process and cannot be released for their intended use can also be recycled. Before recycling such batteries, it is sensible to discharge them first as fully as possible, in order to be able to use the remaining energy of the batteries and to improve the subsequent process, e.g. the production of so-called black mass.

### SUMMARY

According to the present disclosure, there is proposed an apparatus for discharging battery units and a method for operating such an apparatus with the features of the independent claims. Advantageous configurations are the subject-matter of the embodiments and of the following description.

The present disclosure proposes a conveyor system to continuously and automatically transport individual battery units into a discharging station for their discharge, and to continuously and automatically remove individual discharged battery units from the discharging station and replace them with advancing new battery units to be discharged, wherein battery units present in the discharging station can be discharged without interruption, regardless of whether battery units are added or removed.

The apparatus according to the disclosure comprises a plurality of carrier units, wherein a battery unit to be discharged can be arranged on each of these carrier units and electrically contacted. In particular, an electrical contacting can be made between the poles of the respective battery unit and corresponding contact elements of the respective carrier unit. It will be appreciated that multiple battery units can also be arranged per carrier unit, wherein for example, a circuit of the battery units arranged on the respective carrier unit can be produced, for example a series circuit or a parallel circuit, or a combination thereof, and wherein this circuit of the battery units can be electrically contacted with the respective carrier unit.

The apparatus further comprises a conveyor system configured so as to transport individual carrier units. This conveyor system can expediently accommodate a plurality of individual conveyor units, for example in the form of individual conveyor belts or transport belts, conveyor rollers, or self-propelled carrier units for transporting the carrier units between different stations of the apparatus. In particular, with the aid of the conveyor system, individual carrier units can be transported individually as needed, or groups of multiple carrier units can also be transported together.

The apparatus further comprises a buffer station, a discharging station, and a removal station. The buffer station is configured so as to accommodate and/or receive and temporarily store individual carrier units on which a battery unit to be discharged is suitably arranged and electrically contacted by means of the conveyor system. The discharging station is configured so as to receive individual carrier units of the carrier units temporarily stored in the buffer station individually and independently from one another. The removal station is configured so as to remove individual carrier units from the discharging station individually and independently from one another using the conveyor system.

In the buffer station, a plurality of carrier units can be provided in order to be individually transported into the discharging station, as needed. Battery units located on the carrier units accommodated in the discharging station can be discharged there. As soon as a battery unit in the discharging station is sufficiently discharged, the respective carrier unit on which this sufficiently discharged battery unit is arranged can be transported into the discharging station by means of the conveyor system. Thus, a space is freed in the discharging station into which a carrier unit temporarily stored in the buffer station automatically advances.

The apparatus further comprises a contacting assembly or discharging arrangement for discharging battery units arranged on the carrier units received in the discharging station. The contacting assembly is configured so as to generate an electrical contact to carrier units accommodated in the discharging station in such a way that a series circuit of battery units is generated, which are arranged on these electrically contacted carrier units so as to discharge battery units of this series circuit and to disconnect the electrical contact to individual carrier units individually and independently from one another so that the battery units arranged on these carrier units are removed from the series circuit individually and independently from one another, in particular without interrupting the series circuit.

Particularly expediently, the contacting assembly allows new battery units to be flexibly and individually added to the series circuit of battery units to be discharged, and further flexibly and individually removes battery units from this series circuit without having to interrupt the series circuit in each case. Thus, a current flow in the series circuit can be continuously maintained, and the battery units integrated in the series circuit can be continuously discharged without interruption.

The residual voltage of a single battery unit can, optionally, be too low to be able to reasonably supply it to a current sink and discharge it sufficiently. Such a series circuit from a plurality of battery units can expediently achieve a sufficiently high voltage level in order to generate a constant current flow through this series circuit and to be able to sufficiently discharge the individual battery units integrated into the series circuit in this manner.

The contacting assembly expediently comprises a mechanical component for mechanically contacting the carrier units accommodated in the discharging station, in particular contacts or poles of this carrier unit, and thus for establishing mechanical and electrical contact to the respective carrier units and electrical contact to the battery units arranged thereon. Furthermore, in addition to this mechanical component, the contacting assembly comprises an electrical component in a particularly expedient manner, in order to determine the respective carrier units or to be able to flexibly integrate the battery units arranged thereon and electrically connected to the carrier units into the series circuit and to be able to disconnect them again, without interrupting the series circuit, i.e. such that there is still a series circuit of the remaining battery units in the discharging station and such that these remaining battery units can continue to be discharged without interruption.

The disclosure provides a means to deliver individual battery units individually and as needed to the discharging station for discharge thereof, in particular as soon as a free space for receiving a carrier unit is available in the discharging station. Accordingly, it is possible to remove individual battery units individually from the discharging station as needed, depending on their current state of charge, and to have a new battery unit to be discharged advanced as soon as possible, in particular simultaneously or at least substantially simultaneously. Expediently, the status of each individual battery unit is monitored in order to perform as fast a replacement as possible when a sufficient discharge is detected. An independent replacement of individual battery units after discharging them is enabled despite variable starting discharge states between 0% and 100%. The buffer station allows battery units to be supplied in sufficient numbers in order to ensure continuous advancing into the discharging station and continuous operation of the discharging station for power supply. Furthermore, it is enabled that the battery units located in the discharging station can be individually and flexibly supplied to and removed from the series circuit. In this way, individual battery units in the discharging station can be individually replaced after sufficient discharging thereof, without there being a disruption to the current flow in the series circuit, i.e. without interruptions in the discharge of the remaining battery units located in the discharging station. The energy withdrawn from the battery units can be provided for further recycling. In this way, a continuous discharge of battery units is enabled, which can be automatically individually replaced and advanced.

The disclosure in particular expediently allows for automatic, high-volume and process-safe discharging of battery units on an industrial scale. Residual energy from battery units can be effectively withdrawn and made usable for consumers, e.g. for an (AC) voltage grid, before the battery units are fed to a recycling process, for example. Energy can be definedly withdrawn from the battery units and, for example, re-energized or re-used. Battery units can be continuously discharged with a constant current, accelerating the discharge and reducing grid variances in the feed. Furthermore, the disclosure can ensure a high level of process safety, in particular with regard to work and fire protection, by safely and fully removing the residual energy of the battery units. The disclosure enables the realization of large-volume systems in which production returns and field returns (end-of-life energy storage) can be supplied to the material recycling in a manner that is process-safe and automatic as far as possible. Legislation related to the extensive expansion of electromobility, e.g. minimum recyclate rates of valuable metals in the production of new energy storage apparatuses, can thus be met.

Advantageously, the contacting assembly comprises contact elements, each of which is configured so as to be brought into contact with carrier units accommodated in the discharging station and thus electrically contacted. These contact elements in particular expediently constitute a mechanical component for mechanically contacting the carrier units received in the discharging station and thus for establishing a mechanical and electrical contact with the respective carrier units. For example, these contacting elements can be movable such that the contacting elements can be moved towards and away from carrier units received in the discharging station in order to establish or disconnect the electrical contact with these carrier units. For this purpose, the contacting elements can each have, for example, contact pins or contact bolts. For example, the contacting elements can be moved by means of pneumatic or hydraulic actuators, e.g. cylinders.

Advantageously, the contacting assembly comprises a switch assembly having a plurality of switch units configured so as to generate the series circuit of battery units arranged on the electrically contacted carrier units, in particular brought into contact with the contact elements. In particular, by opening (=non-conductive) or closing (=conductive) the individual switch units, individual battery units can be received in or removed from the battery series circuit, in particular such that neither the addition nor removal of the corresponding series circuit must be interrupted. For example, the contacting assembly for each carrier unit can each comprise two switch elements, which can each be configured e.g. as mechanical or electronic switches, e.g. as power semiconductor switch elements, transistors, etc. A first one of these switch elements can be suitably switchable in parallel with the respective carrier unit or battery unit, and a second one of these switch elements can be switchable in series with the respective carrier unit or battery unit. By controlling the respective switch elements, battery units to be discharged can be flexibly connected to and disconnected from the series circuit. In addition to the switch units, the switch assembly can expediently comprise other electrical or electronic elements, e.g. diodes, capacitors, etc. Expediently, individual electrical or electronic elements of the switch assembly can be integrated into or electrically connected to the contact elements. Particularly expediently, the switch assembly comprises DC voltage connections for providing a DC voltage when at least one battery unit is integrated in the series circuit.

Advantageously, the contacting assembly comprises a discharge circuit configured so as to discharge battery units of the series circuit. For example, the discharging circuit can be a sink or a load in order to withdraw a current flow from the series circuit of the battery units. Furthermore, the discharging circuit can be used, for example, as a current or voltage source in order to feed the energy withdrawn from the battery units into a voltage grid. Expediently, the discharging circuit allows the energy withdrawn from the battery units to be controlled or regulated and monitored. For example, the discharge circuit can comprise a power converter circuit that raises the DC voltage withdrawn from the battery units to a higher voltage level. Furthermore, the power converter circuit can convert this DC voltage into, for example, an AC power output voltage suitable for an AC voltage network. Particularly expedient, this discharging circuit can be connected to the DC voltage terminals of the switch assembly in order to further process the DC voltage supplied by the switch assembly, e.g. for provision in a (DC or AC) voltage grid.

According to a more advantageous configuration, each carrier unit has fixed contact elements and flexible, non-rigid conduit connections, wherein the fixed contact elements are electrically connectable to a battery unit arranged on the carrier unit via the flexible conduit connections. For example, a battery unit to be discharged can be mounted or fastened on the carrier unit automatically or manually. The flexible conduit connections can each be configured as a cable tail or cable hose, for example. These flexible conduit connections make it particularly convenient to flexibly connect the fixed contact elements of the carrier unit to battery units of different types and sizes. Furthermore, the respective battery unit can be flexibly arranged on the carrier unit and need not necessarily be mounted in an exactly provided space. For example, the carrier units can further each comprise a measuring device in order to check whether an electrical contacting to the respective battery unit has been successfully established. Alternatively or additionally, such a check can also be carried out in a stationary manner in the apparatus, for example, in a loading station explained below. For example, each carrier unit can also comprise multiple fixed contact elements, each of which can be connected to a battery unit via a flexible conduit connection, so that a plurality of battery units can also be arranged per carrier unit.

Particularly expediently, the aforementioned, in particular movable, contact elements of the contacting assembly are configured so as to be brought into contact with these fixed contact elements of the carrier unit in order to thus establish the electrical contacting to this carrier unit and to the battery unit arranged thereon. For example, the fixed contact elements can each represent a standardized connector. The contact elements of the contacting assembly in particular represent a corresponding, standardized counterpart for this connector. In this way, in particular, a standardized connection between the carrier unit and the discharging station can be provided, which allows for automated discharge and allows the apparatus to cope with a high variance in battery units. Furthermore, the flexible conduit connections can provide, for example, a suitable counterpart to the connections, contacts, or poles of the respective battery unit depending on the battery unit to be contacted.

Advantageously, the apparatus further comprises a safety station configured so as to receive individual carrier units from the discharging station directly and immediately by means of the conveyor system and to act upon them by means of safety mechanisms. In a safety-critical emergency, such as a fire of a battery unit or an irreversible, undesirable chemical reaction occurring in a battery unit, this defective battery unit can be immediately removed from the discharging unit and carried into the safety station, in order to counteract this emergency there by means of the safety mechanisms. The safety station can in particular be used as an extinguishing or abatement station, and the safety mechanisms can comprise, for example, a fire-resistant gel bath and an extinguishing device. For example, physical quantities can be monitored when discharging the battery units in order to detect a corresponding safety-critical emergency, e.g. temporal curves of current, voltage, temperature, etc., and/or sensors can be used in the discharging station, e.g. smoke sensors, sniffing sensor, etc. If, for example, an undesirable heating of a battery unit beyond a specified limit value is determined by means of the monitoring technique used, then the contacting to that battery unit or to the respective carrier unit can be immediately interrupted, e.g. by returning the respective contact elements of the contact arrangement, e.g. the contact bolt, to their home position. The respective battery unit can then be unloaded into the safety station, where the corresponding safety mechanisms are introduced, e.g. lowering the battery unit into a fire-retardant gel bath or other adequate extinguishing device.

Preferably, the apparatus further comprises a charging station in which a respective battery unit can be arranged and contacted on individual carrier units. The conveyor system, in particular a corresponding conveyor unit of the conveyor system, is configured so as to transport individual carrier units from the loading station to the buffer station, and the buffer station is configured so as to receive and temporarily store individual carrier units from the loading station by means of the conveyor system or by means of the respective conveyor unit. As soon as a carrier unit is fitted with a battery unit for discharging in the loading station, this carrier unit can be conveniently transported to the buffer station automatically by means of the conveyor system. For example, this loading station can be a (manual) work station where the battery units are manually arranged on the carrier units by an operator and contacted thereto. Furthermore, the loading station can also represent an automated unit in which the loading and/or contacting occurs automatically. The loading station can be suitably separated and segregated from the discharging station. Particularly expediently, the discharging station can be in a protected region, e.g. inside a guard fence. In this way, a protection of the operator can be ensured, in particular, a contact and work protection.

Preferably, the apparatus further comprises a withdrawal station configured so as to receive individual carrier units from the removal station by means of the conveyor system. In this withdrawal station, battery units arranged in and discharged from the received carrier units can be electrically disconnected from the respective carrier unit. Expediently, carrier units can be transported continuously and sequentially into the withdrawal station by means of the conveyor system. In particular, the withdrawal station and the loading station are coupled by means of the conveyor system so that discharging carrier units can be transported from the withdrawal station to the loading station for reloading. In this way, in particular, a self-contained conveyor circuit can be realized. Like the loading station, this withdrawal station can be a (manual) work station where the battery units are manually removed from the carrier units by an operator. As well as the loading in the loading station, this removal of the battery units can occur in particular in a separate station, which is separated and segregated from the discharging station in order to ensure the protection of the operator. Furthermore, the withdrawal station can also be an automated unit in which the disconnection of the contacting and/or removal of the battery units occur automatically.

According to a particularly preferred configuration, the buffer station comprises one or more buffer units, wherein each of these buffer units is respectively configured for intermediate storage of a carrier unit, in particular until the respective carrier unit is to be transported to the discharging station. Preferably, the discharging station comprises one or more discharging units, wherein each of which discharging units is each configured so as to receive a carrier unit from one of the buffer units of the buffer station by means of the conveying system. The contacting assembly for each of these discharging units expediently comprises a contact element for establishing the electrical contacting with the carrier unit received in this respective discharging unit. In particular, the number of discharging stations can be varied in order to be able to scale the power supplied. Preferably, one of the buffer units is respectively assigned to one of the discharging units, and buffer units and discharging units assigned to one another are respectively coupled via a common conveying unit of the conveyor system, e.g. via a common conveyor belt. By means of these conveying units, individual battery units from the individual buffer units can advance directly and immediately into the respectively allocated discharging unit as needed, in particular as soon as this discharging unit is empty again, i.e. in particular as soon as the carrier unit previously received in this respective discharging unit has been transported. Expediently, the individual buffer units are arranged in a first direction adjacent to one another. The individual discharging units are suitably also arranged adjacent to one another in this first direction. Buffer units and discharging units assigned to one another are arranged in particular in a second direction, in particular perpendicular to the first direction, respectively next to one another and in front of one another. Carrier units can be transported from the individual buffer units to the respectively assigned discharging unit by means of the respective conveyor units in the second direction. Furthermore, carrier units can be suitably transported in the first direction by means of the conveyor system between individual buffer units. For example, if fewer carrier units than buffer units are available, individual carrier units can be flexibly transported in this manner to those buffer units whose assigned discharging units are empty.

According to an advantageous configuration, the removal station comprises an emptying station and a second buffer station. The emptying station is configured so as to receive individual carrier units from the discharging station individually and independently from one another. After a battery unit arranged on a carrier unit has been discharged, this carrier unit can be transported individually into the emptying station. The second buffer station is referred to as an accumulation station or accumulation conveyor and is configured so as to receive and temporarily store carrier units received in the emptying station by means of the conveyor system. Expediently, the carrier units temporarily stored in the second buffer station can be transported continuously and one after the other into the withdrawal station by means of the conveyor system. Particularly advantageously, all carrier units are transported together from the emptying station to the second buffer station. For example, if multiple battery units are sufficiently discharged at the same time, the respective carrier units can be conveniently transported into the emptying station at the same time and transported together from there into the second buffer station. However, if insufficient spaces are present in the second buffer station in order to receive all the carrier units to be transported from the discharging station, the transport of these carrier units to the emptying station is first paused until sufficient space is present in the second buffer station. In this way, it can be achieved that no accumulation of carrier units to be removed occurs in the emptying station until they are placed in free spaces in the second buffer station or accumulation station. Thus, the emptying station can always be kept free so that, in a safety-critical emergency, a defective battery unit can be immediately removed from the discharging station into the safety station. The emptying station is expediently configured so as to directly and immediately receive individual carrier units from the discharging station via the conveyor system, wherein said carrier units are directly and immediately transportable from the emptying station to the safety station via the conveyor system. Expediently, the emptying station can lead directly to the safety station so that, in an emergency, a defective battery unit can be transported to the safety station in the shortest and fastest possible way.

According to a preferred configuration, the emptying station comprises one or more emptying units, wherein each of these emptying units is configured so as to receive a carrier unit from one of the discharging units of the discharging station by means of the conveyor system. Preferably, one of the emptying units is respectively assigned to one of the discharging units and consequently one of the buffer units. Buffer units, discharging units, and emptying units assigned to one another are preferably coupled via the respective conveying units of the conveyor system. In particular, the individual emptying units are arranged next to one another in the first direction, and buffer units, discharging units, and emptying units assigned to one another are arranged next to one another and in front of one another, respectively, in the second direction. Individual battery units can thus advance directly and immediately from the buffer units in the second direction to the respectively assigned discharging unit as soon as the carrier unit previously received in that respective discharging unit has been transported in the second direction to the respectively assigned emptying unit. Furthermore, the safety station can be arranged in particular in the first direction adjacent to the emptying units.

Advantageously, the buffer station, the discharging station, and the removal station are arranged within a protected region, e.g., inside a protective fence. Particularly expediently, the loading station and the withdrawal station, in which the battery units are manually placed on and withdrawn from the carrier units by an operator, are arranged outside of this protected region. For example, a high voltage range can be defined within the protected region in which high voltages can occur during discharge of the battery units, for example from 75V to 1000V. Outside of the protected region, in particular, a low voltage range can be defined, in which low voltages of, for example, below 75V can occur during manual handling of the battery units. Particularly expediently, operator safety can be ensured by automated removal of the carrier units from the loading station to the protected region by means of the conveyor system, by automated processing of the carrier units within the protected region, and by automated transport of the carrier units by way of the conveyor system from the protected region to the withdrawal station. In particular, protection against contact can be ensured so that a touching of the high voltage and the risk of electric shock within the protected region can be ruled out.

The disclosure further relates to a method for operating an apparatus according to the disclosure above for discharging battery units. Advantages and advantageous configurations of the apparatus according to the disclosure and the method according to the disclosure arise from the present description in a corresponding manner.

The present method comprises an arrangement of in each case one respective battery unit on an individual carrier unit and an electrical contacting of the individual carrier units with the respective battery unit arranged thereon, in particular as a manual working step in the loading station.

Furthermore, there is a transport of individual carrier units, on which a battery unit is respectively arranged, by means of the conveyor system into the buffer station and an intermediate storage of these carrier units in the buffer station. In the course of the above, the carrier units can in particular be distributed into the individual buffer units, expediently until one carrier unit is available in each buffer unit. This transporting and distribution among the individual buffer units is in particular automated and can be controlled by a control unit of the apparatus. In particular, the control unit ensures that there are always sufficient carrier units available for advancing so that the discharging station can provide a continuous discharging current.

Furthermore, there is a transport of individual carrier units individually and independently from one another by means of the conveyor system from the buffer station into the discharging station. Individual carrier units can advance from their respective buffer unit to the assigned discharging unit. This advancing is also in particular automated and is expediently controlled by the control unit.

An electrical contact is generated between the contacting assembly and the carrier units received in the discharging station and a series circuit of battery units arranged on said electrically contacted carrier units is generated. The contact can be automated by moving the individual contact elements to the carrier units received in the discharging units, in particular controlled by the control unit. The series circuit is in particular generated by controlling the individual switch units of the switch assembly, in particular controlled by the control unit.

The battery units of the series circuit are discharged using the contacting assembly, in particular using the discharge circuit. The discharging operation of each individual battery unit can be monitored and controlled by the control unit. In particular, the energy withdrawn from the battery units can be provided in a controlled manner for further use.

The electrical contact between the contacting assembly and individual carrier units received in the discharging station is disconnected individually and independently from one another, and the battery units arranged on said respective carrier units are removed from the series circuit individually and independently from one another, expediently without interrupting the series circuit, in each case when a specified event occurs, which characterizes a sufficient discharge of the battery unit arranged on said respective carrier units. Thus, when it is detected that a battery unit is fully discharged, this battery unit is removed from the series circuit again by controlling the switch assembly, and the respective contact element of the contacting assembly is moved away from the respective carrier unit.

The respective carrier units, the electrical contact of which has been disconnected from the contacting assembly, are then transported from the discharging station to the removal station individually and independently from one another by means of the conveyor system, in particular automated and controlled by the control unit. These carrier units can then be transported to the withdrawal station, where the discharged battery units are withdrawn. The empty carrier units are then fed back to the loading station.

For example, a voltage path of the individual battery units can be monitored in order to detect this event. The specified event can in particular characterize a loss of the electrochemical property or the capability of the respective battery unit to store a charge or a charge carrier in the battery unit. The specified event then, in particular, characterizes the inactivation of the respective battery unit and the loss of the storage behavior or capability of the battery unit and expediently characterizes a destruction of the battery unit. In the course of the (deep) discharge, the charge carriers are expediently first depleted, and then the internal storage structure of the battery units is destroyed. This in particular results in the battery units losing their main function as of a certain state and being unable to charge or discharge. A return of the battery voltage is then in particular no longer possible. Such deeply discharged battery units can then be suitably fed to a recycling process so that process safety, in particular work and fire protection, can be ensured. Such a defined withdrawal of the charge from the battery units can in particular achieve a defined deep discharge state.

For example, the specified event can occur when a measured variable of the respective battery unit, e.g. a state of charge or a voltage value, reaches a specified threshold value, e.g. 0% state of charge or 0V terminal voltage, and when a further discharge of the battery unit occurs after this threshold value is reached, until a specified amount of charge has been withdrawn from the battery unit. Furthermore, the specified event can occur, for example, when a voltage curve of the respective battery unit has a specified feature, for example, until the voltage curve reaches a constant or at least substantially constant negative saturation voltage value.

Advantageously, a transport or an automated advancing of a carrier unit from one of the buffer units to the respectively assigned discharging unit takes place as soon as the carrier unit previously transported into this discharging unit is transported by means of the conveyor system into the removal station, in particular into the respectively assigned emptying unit. Thus, after a battery unit has been fully discharged and the respective carrier unit has been removed, a subsequent advancement of a new battery unit to be discharged takes place as soon as possible. Particularly expediently, the control unit ensures that discharge battery units are replaced immediately upon reaching the electrochemical inactivity in the discharging unit.

Preferably, a voltage and a temperature of battery units arranged on the contacted carrier units in the discharging unit are determined and monitored. Based on the voltage, in particular a terminal voltage between terminals of the respective battery unit, the current state of charge thereof can in particular be inferred. This voltage can in particular be used in order to detect the occurrence of the respective event, which characterizes a sufficient discharging of the respective battery unit. With the help of the determined temperature, the individual battery units can be monitored for the occurrence of safety-critical emergencies, in particular. Furthermore, the voltage and temperature can in particular be used for controlling and regulating the discharging process.

Preferably, a discharging current for discharging the battery unit arranged on the contacted carrier unit is regulated in the discharging unit. In particular, by controlling the discharge circuit, a corresponding current regulation can be carried out, in particular such that a constant (discharging) current is withdrawn from the individual battery units of the series circuit.

Advantageously, a discharge rate for discharging the battery unit arranged on the contacted carrier unit is controlled. For example, this control can be based upon the temperature, voltage, and/or current flow of the individual battery units.

The disclosure is expediently suitable for a plurality of different battery units, in particular for battery units from the (motor or electric) vehicle region or electric drive technology. For example, individual battery units can each comprise a so-called battery cell, which is understood as a smallest battery unit installed in a vehicle, which, for example, can have a cell voltage between 2.5 V and 4.4 V. Furthermore, individual battery units can each be configured as, for example, a battery module, which in particular is understood as a series circuit of multiple such battery cells, which, for example, can have a nominal voltage of up to 60V. For example, individual battery units can also each be a battery pack, which is a series circuit from a plurality of such battery modules, which can have a rated voltage of 200V to 1000V, for example.

Additional advantages and configurations of the disclosure result from the description and the enclosed drawing.

It is understood that the aforementioned features and the features yet to be explained below can be used not only in the respectively specified combination but also in other combinations or alone, without leaving the scope of the present disclosure.

The disclosure is thoroughly illustrated schematically in the drawing on the basis of embodiment examples and is described below with reference to the drawing.

### BRIEF DESCRIPTION OF THE DRAWINGS

In the drawings:

FIG. 1 schematically shows a preferred configuration of an apparatus according to the disclosure;

FIGS. 2a and 2b schematically show a carrier unit of a preferred configuration of an apparatus according to the disclosure; and

FIG. 3 schematically shows elements of a contacting assembly of a preferred configuration of an apparatus according to the disclosure.

### DETAILED DESCRIPTION

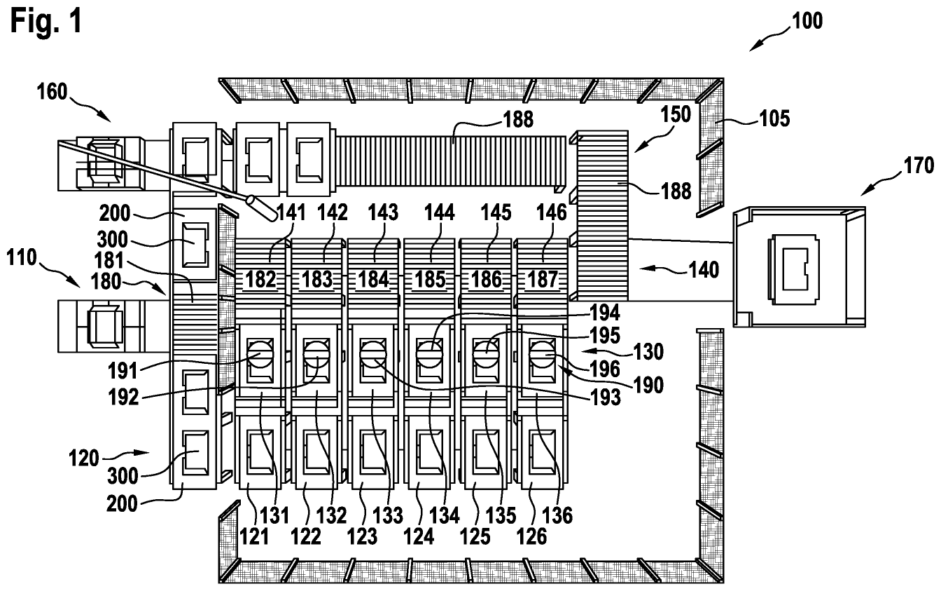

In FIG. 1, a preferred configuration of an apparatus according to the disclosure for discharging battery units in a schematic top plan view is shown and designated with the reference number 100.

The apparatus 100 comprises a plurality of carrier units 200 on which a respective battery unit 300 can be arranged and electrically contacted. By means of a conveyor system 180, these individual carrier units 200 can be transported between different stations. For this purpose, the conveyor system 180 comprises a plurality of individual conveyor units, for example, each in the form of individual conveyor belts or conveyor rollers, which can be driven individually and independently from one another. It will be appreciated that other conveyor units, for example also in the form of self-propelled carrier units, can also be provided.

In a charging station 110, a respective battery unit 300 can be arranged and contacted sequentially on individual carrier units 200. For example, this loading station 110 can be provided as a manual work station. By means of the conveyor system 180, in particular by means of a first conveyor unit 181, correspondingly loaded carrier units 200 are transported from the loading station to a buffer station 120. In this buffer station 120, individual carrier units 200 are temporarily stored. The buffer station 120 has a plurality of buffer units 121, 122, 123, 124, 125, 126, wherein each of these buffer units 121, 122, 123, 124, 125, 126 is configured so as to temporarily store a carrier unit 200.

A discharging station 130 comprises a plurality of discharging units 131, 132, 133, 134, 135, 136, wherein each of these discharging units 131, 132, 133, 134, 135, 136 is configured so as to receive a carrier unit 200 from one of the buffer units 121, 122, 123, 124, 125, 126. Individual carrier units 200 are transported out of the buffer station into the discharging station 130 by means of the conveyor system 180 individually and independently from one another, in particular when a corresponding discharging unit is or becomes free in the discharging station. For this purpose, one of the buffer units 121, 122, 123, 124, 125, 126 is respectively assigned to one of the discharging units 131, 132, 133, 134, 135, 136. Buffer units and discharging units assigned to one another are respectively coupled via a conveyor unit 182, 183, 184, 185, 186, 187 of the conveyor system 180. In the example of FIG. 1, each of the vertically adjacent buffer units 121, 122, 123, 124, 125, 126 and discharging units 131, 132, 133, 134, 135, 136 are associated with one another and are coupled via a conveyor unit.

A contacting assembly 190 is configured so as to generate an electrical contacting with carrier units 200 received in the discharging station, such that a series circuit of battery units 300 arranged on said electrically contacted carrier units 200 is generated. Furthermore, the contacting assembly 190 is configured so as to discharge battery units 300 of this series circuit and disconnect the electrical contacting to individual carrier units 200 individually and independently from one another such that the battery units 300 arranged on these carrier units are removed from the series circuit individually and independently from one another.

Using the contacting assembly 190, a plurality of battery units 300 arranged in the discharging station 130 can be integrated into a series circuit and discharged simultaneously. When a specified event occurs, which characterizes sufficient discharge of one of the battery units 300 connected in series at the discharging station 130, the electrical contact between the contacting assembly 190 and the carrier unit of the sufficiently discharged battery unit 300 is disconnected, and this battery unit 300 is removed from the series circuit without interrupting the series circuit. The series circuit is maintained, and the remaining batteries continue to be discharges.

The contacting assembly has for each discharging unit 131, 132, 133, 134, 135, 136 respective movable contact elements 191, 192, 193, 194, 195, 196, for example movable contact bolts, which can respectively be moved towards a carrier unit 200 arranged in the respective discharging unit 131, 132, 133, 134, 135, 136, until they touch this carrier unit 200, whereby an electrical contacting is made to the carrier unit 200 and the battery unit 300 arranged thereon. By moving the contact elements 191, 192, 193, 194, 195, 196 accordingly, the electrical contacting to the respective battery unit 300 is disconnected again.

A removal station is configured so as to remove individual carrier units 200 from the discharging station individually and independently from one another using the conveyor system 180. A carrier unit 200, whose electrical contacting with the contacting assembly 190 has been disconnected, can thus be transported from the discharging station 130 by way of the conveyor system 180 individually and independently from the other carrier units. This removal station has an emptying station 140 and a second buffer station 150. Individual carrier units 200 can be transported to the emptying station 140 individually and independently from the discharging station 130 by means of the conveyor system 180. Carrier units 200 received in the emptying station 140 can be transported to and temporarily stored in the second buffer station 150 by means of a conveyor unit 188 of the conveyor system 180, in particular all carrier units 200 commonly from the emptying station 140.

The emptying station 140 has a plurality of emptying units 141, 142, 143, 144, 145, 146. Each of these emptying units 141, 142, 143, 144, 145, 146 is configured so as to receive a carrier unit 200 from one of the discharging units of the discharging station 120. In each case, one of the emptying units 141, 142, 143, 144, 145, 146 is respectively assigned to one of the discharging units 131, 132, 133, 134, 135, 136. Each of the respectively assigned discharging units 131, 132, 133, 134, 135, 136 and the discharging units 141, 142, 143, 144, 145, 146 are coupled via respective common conveying units 182, 183, 184, 185, 186, 187 of the conveying system. In particular, each of the respectively assigned buffer units 121, 122, 123, 124, 125, 126, discharging units 131, 132, 133, 134, 135, 136, and emptying units 141, 142, 143, 144, 145, 146 can be coupled via the respective common conveying units 182, 183, 184, 185, 186, 187 of the conveyor system, such that, at the same time, a transfer of a transport unit to be discharged from a buffer unit to a discharging unit, and a discharged transport unit from this discharging unit into an emptying unit.

Furthermore, a safety station 170 is provided and is configured so as to receive individual carrier units 200 from the discharging station 130 by means of the conveyor system 180 and to impinge them by means of safety mechanisms. In a safety-critical emergency, such as a fire of a battery unit 300 or an irreversible, undesirable chemical reaction occurring in a battery unit 300, this defective battery unit 300 can be immediately removed from the discharging unit 120 and carried into the safety station 170. The safety mechanisms there can counteract the emergency and can comprise, for example, a fire-resistant gel bath and an extinguishing device. In particular, the emptying station 140 passes directly into the safety station 170. In particular, only as many carrier units are transported from the discharging station 130 into the emptying station 140 as can be jointly received by the second buffer unit 150. If insufficient spaces are present in the second buffer station 150 in order to receive all the carrier units 200 to be transported from the discharging station 130, the transport of these carrier units 200 to the emptying station 140 is paused until sufficient space is present in the second buffer station 150. Thus, no accumulation of carrier units 200 that are to be removed can occur in the emptying station 140, and the emptying station 140 can always be kept free so that, in a safety-critical emergency, a defective battery unit 300 can be immediately removed from the discharging station 120 into the safety station 170.

The carrier units 200 temporarily stored in the second buffer unit 150 with the discharged battery units 300 arranged thereon are fed sequentially to a withdrawal station 160 in which the discharged battery units 300 can be electrically disconnected and withdrawn from the respective carrier unit. The emptied carrier units 200 can then be fed back to the loading station 110 via the first conveyor unit 181. Like the loading station 110, the withdrawal station 160 can also be a manual work station.

The buffer station 120, the discharging station 130, the emptying station 140, and the second buffer station 150 are preferably arranged within a protected region in the form of a protective fence 105. The manual work stations in the form of the loading station 110 and the withdrawal station 160 are thus arranged outside of this protective fence 105 so that operators in these stations 110, 160 are protected from high voltages, etc. during battery discharge.

The apparatus 100 thus allows individual battery units 300 to be fed to the discharging station 130 individually and as needed, removed from the discharging station 130 upon discharge thereof, and allow a new battery unit 300 to be discharged to be advanced. In the buffer station 120, sufficient battery units 300 can be provided in order to ensure continuous advancing into the discharging station 120. By allowing the contacting assembly 190 to generate a series circuit of the battery units 300 arranged in the discharging station 130, and in that individual battery units 300 can be added to and removed from that series circuit without interrupting the series circuit, a continuous current flow for battery discharge can be generated and maintained. In this way, a continuous discharge of battery units 300 is enabled, which can be automatically individually replaced and advanced.

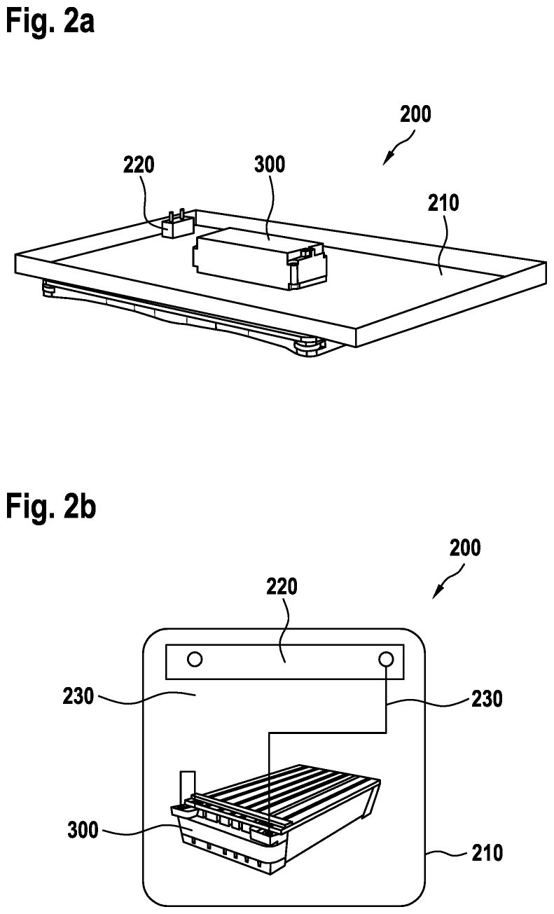

One of the carrier units 200 of the apparatus 100 is shown in FIG. 2a in a schematic perspective view and in FIG. 2b in a schematic top plan view according to a preferred configuration of the disclosure. The carrier unit 200 has a carrier floor 210 on which the battery unit 300 can be arranged. A fixed contact element 220 is provided on the carrier floor 210, which can be electrically connected to poles of the battery unit 300 via flexible, non-rigid conduit connection 230. Such an arrangement of the battery unit 300 and electrically connecting the battery unit 300 to the fixed contact element 220 can conveniently be done manually in the loading station 110. The individual movable contact elements 191, 192, 193, 194, 195, 196 of the contacting assembly 190 are each configured so as to touch the contact element 220 of the carrier unit 200 and thus make electrical contact with the battery unit 300.

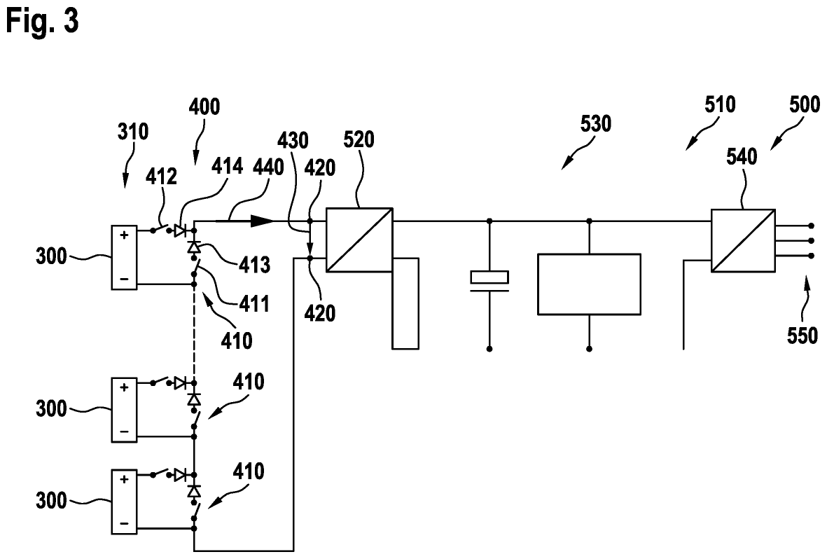

The contact elements 191, 192, 193, 194, 195, 196 represent a mechanical component of the contacting assembly 190 for establishing electrical contact with the battery units 300. The contacting assembly 190 further comprises electrical components for being able to flexibly integrate and disconnect the battery units from the series circuit, as will be explained in FIG. 3 below.

FIG. 3 shows elements of a contacting assembly 190 according to a preferred configuration of the disclosure in a simplified, schematic, electrical circuit diagram.

The contacting assembly 190 comprises a switch assembly 400 configured so as to generate a corresponding series circuit 310 from a plurality of battery units 300. For this purpose, the switch assembly 400 for each battery unit 300 comprises a connection circuit 410 with two switch elements 411, 412 and two diodes 413, 414, wherein the diode 414 is optional. For example, one of each of these connection circuits 410 can be integrated into each of the movable contact elements 191, 192, 193, 194, 195, 196.

A first one of these switch elements 411 can be connected in parallel to the respective battery unit 300, and a second one of these switch elements 412 can be connected in series to the respective battery unit 300. By controlling the switch elements 411, 412, the respective battery unit 300 can be flexibly connected to and disconnected from the series circuit 310 without interrupting the series circuit 310, so that a constant current flow 440 is maintained. When at least one battery unit 300 is integrated into the series circuit 310, a DC voltage 430 is provided to DC voltage terminals 420 of the switch assembly 400.

The contacting assembly 190 further comprises a discharge circuit 500 configured so as to discharge the battery units 300 of the series circuit 310. For example, the discharging circuit 500 can comprise a power source and sink 510 for this purpose in order to remove the constant current flow 440 from the series circuit 310 and to feed the power withdrawn from the battery units 300 into a voltage grid. For example, this power source and sink 510 can be provided as a power converter circuit in order to convert the DC voltage 430 supplied to the DC voltage terminals 420 of the switch assembly 400 into an AC voltage for supply to an AC power system. For this purpose, the power converter circuit 510 can comprise, for example, a DC voltage converter circuit 520, an internal DC voltage circuit 530, and an inverter circuit 540. The generated AC voltage can be supplied to phase terminals 550 and fed into the AC power system.

Furthermore, in the course of discharging using the discharge circuit 500, a voltage of the individual battery units 300 is monitored, for example a terminal voltage between terminals of the individual battery units 300. This voltage is investigated for the occurrence of the event, which characterizes a sufficient discharging of the respective battery units 300. In particular, this event characterizes the loss of the electrochemical property or the capability of the respective battery unit 300 to store a charge or a charge carrier. For example, the specified event can occur when the voltage value of the clamp voltage reaches a specified threshold value of, for example, 0V, and when a specified amount of charge has further been removed from the respective battery unit 300 after reaching this threshold value. Furthermore, the specified event can occur, for example, when a path of the clamp voltage as a specified characteristic reaches a constant or at least substantially constant negative saturation voltage value.

What is claimed is:

1. An apparatus for discharging battery units, comprising:
a plurality of carrier units, wherein a respective battery unit is arranged on top of each of the plurality of carrier units and is configured to be electrically contacted;
a conveyor system configured to transport individual carrier units of the plurality of carrier units;
a buffer station configured to receive and temporarily store a number of the plurality of carrier units;
a discharging station configured to receive the individual carrier units transported from the buffer station;
a removal station configured to remove the individual carrier units transported from the discharging station;
a contacting assembly configured to generate a respective electrical contact to each of the individual carrier units received in the discharging station such that a series circuit of battery units is generated, which are arranged on the electrically contacted individual carrier units to discharge the series circuit of battery units and to disconnect the respective electrical contacts to each of the individual carrier units individually and independently from one another so that the individual battery units arranged on the carrier units are removed from the series circuit individually and independently from one another.

2. The apparatus according to claim 1, wherein the contacting assembly comprises:
a plurality of contact elements, each of the plurality of contact elements configured to be brought into contact with respective ones of the individual carrier units received in the discharging station and thus to be electrically contacted;
a switch assembly comprising a plurality of switch units configured so as to generate the series circuit of battery units arranged on the electrically contacted individual carrier units; and
a discharge circuit configured so as to discharge the individual battery units of the series circuit.

3. The apparatus according to claim 1, wherein:
each individual carrier unit comprises respective fixed contact elements and flexible conduit connections; and
the fixed contact elements are electrically connectable to the respective battery unit arranged on the carrier unit via the flexible conduction connections.

4. The apparatus according to claim 1, further comprising:
a safety station configured to receive the individual carrier units from the discharging station and to impinge them using one or more safety mechanisms.

5. The apparatus according to claim 1, wherein at least one of:
the apparatus further comprises a loading station in which the respective battery unit is arranged on top of the individual carrier units,
the conveyor system is configured to transport the individual carrier units from the loading station to the buffer station, and
the buffer station is configured to receive and temporarily store the individual carrier units from the loading station; and
the apparatus further comprises a withdrawal station configured to receive the individual carrier units from the removal station, and
respective battery units arranged in the received individual carrier units in the withdrawal station are configured to be electrically disconnected and withdrawn from the respective carrier unit.

6. The apparatus according to claim 1, wherein:
the buffer station comprises at least one buffer unit, wherein each of the at least one buffer units is respectively configured to temporarily store an individual carrier unit;
the discharging station comprises at least one discharging unit, wherein each of the at least one discharging units is configured to receive a respective individual carrier unit from one of the at least one buffer units of the buffer station;
each of the at least one buffer units is respectively assigned to one of the at least one discharging units; and
buffer units and discharging units assigned to one another are respectively coupled via a respective one of at least one conveying unit of the conveyor system.

7. The apparatus according to claim 6, wherein the removal station comprises:
an emptying station configured to receive the individual carrier units from the discharging station individually and independently from one another; and
a second buffer station configured to receive all of the individual carrier units received in the emptying station and to temporarily store them.

8. The apparatus according to claim 7, wherein;
the emptying station comprises at least one emptying unit;
each of the at least one emptying unit is configured to receive a respective individual carrier unit from a respective one of the at least one discharging unit of the discharging station;
each of the at least one discharging units is respectively assigned to one of the at least one discharging units; and
buffer units, discharging units, and emptying units assigned to one another are coupled via the respective one of the at least one conveying unit of the conveyor system.

9. The apparatus according to claim 1, wherein the buffer station, the discharging station, and the removal station are arranged within a protected region.

10. A method for operating an apparatus for discharging battery units, comprising:
arranging a respective battery unit on individual carrier units of a plurality of carrier units and electrically contacting the individual carrier units with the respective battery unit arranged thereon;
transporting the individual carrier units, on which the respective battery unit is arranged, using a conveyor system, into a buffer station and temporarily storing the individual carrier units in the buffer station;
transporting the individual carrier units individually and independently from one another, using the conveyor system, from the buffer station into a discharging station;
generating an electrical contact between a contacting assembly and the individual carrier units received in the discharging station and generating a series circuit of the respective battery units arranged on said electrically contacted individual carrier units;
discharging the respective battery units of said series circuit using the contacting assembly;
disconnecting the electrical contact between the contacting assembly and the individual carrier units received in the discharging station individually and independently from one another and removing the respective battery units arranged on said individual carrier units from the series circuit individually and independently from one another, in response to occurrence of a specified event which characterizes a sufficient discharge of the respective battery unit arranged on said individual carrier units; and
transporting, using the conveying system, the individual carrier units, whose electrical contacting to the contacting assembly has been disconnected from one another individually and independently, from the discharging station into a removal station configured to remove the individual carrier units transported from the discharging station from the conveyor system.

11. The method according to claim 10, wherein the buffer station comprises at least one buffer unit and the discharging station comprises at least one discharging unit, further comprising:
transporting a second of the individual carrier units from a first of the at least one buffer units into a first of the at least one discharging units as soon as a first of the individual carrier units previously transported into the first of the at least one discharging units is transported by the conveyor system into the removal station.

12. The method according to claim 10, further comprising at least one of:
determining and monitoring a voltage and a temperature of the respective battery units arranged on the contacted individual carrier units in the discharging unit; and
regulating a discharging current which discharges the respective battery unit arranged on the contacted individual carrier unit in the discharging unit; and
controlling a discharge rate which discharges the respective battery unit arranged on the contacted individual carrier unit.
